(19) United States
(12) Patent Application Publication
(10) Pub. No.: US 2003/0191658 A1
(43) Pub. Date: Oct. 9, 2003

(54) Method of disposal of security documents

(76) Inventor: Robert C. Rajewski, Stettler (CA)

Correspondence Address: THOMPSON LAMBERT, SUITE 703D, CRYSTAL PARK TWO, 2121 CRYSTAL DRIVE, ARLINGTON, VA, 22202

(21) Appl. No.: 10/121,869

(22) Filed: Apr. 15, 2002

(30) Foreign Application Priority Data
Apr. 5, 2002 (CA) 2380510

(51) Int. Cl. G06F 17/60

(52) U.S. Cl. 705/1

(57) ABSTRACT

A method of waste disposal, for example disposal of paper, the method comprising the steps of providing a bin at a recyclable waste collection location, for example an office, for receiving recyclable waste, collecting the recyclable waste from the bin, delivering the recyclable waste to a recycling enterprise in return for a payment, and donating all or at least a portion of the payment to a charity. Indicia of the charity may be displayed at the recyclable waste collection location. Each bin may be associated with an account having a number and payments associated with the bin may be tracked using the account number. The account number may be marked on the bin. The charity may for example be devoted to the interest of children, and may be World Vision. The recyclable waste may be processed, for example by shredding in the case of paper, before delivery to the recycling enterprise.

### BACKGROUND OF THE INVENTION

Paper shredding companies remove paper from offices and other commercial and industrial locations, shred the paper and then provide it to a recycling unit for recycling. This is particularly important for documents requiring secure disposal. The paper shredding companies are paid by the owner or lessee of the location for the amount of paper that is shredded. The paper shredding companies also receive a payment from the recycling unit owner or operator for the paper. While this process works, the proceeds are only shared among the participants.

### SUMMARY OF THE INVENTION

This invention provides an enhanced method for secured disposal of secured documents, and also a method for the sharing of proceeds of a recycling operation, for example a paper shredding operation.

There is therefore provided in accordance with an aspect of the invention, a method of waste disposal, particularly secure disposal of paper, the method comprising the steps of providing a bin at a recyclable waste collection location, for example an office, for receiving recyclable waste, collecting the recyclable waste from the bin, delivering the recyclable waste to a recycling enterprise in return for a payment, and donating all or at least a portion of the payment to a charity. Indicia of the charity may be displayed at the recyclable waste collection location. Each bin may be associated with an account having a number and payments associated with the bin may be tracked using the account number. The account number may be marked on the bin. The charity may for example be devoted to the interest of children, and may be World Vision. The recyclable waste may be processed, for example by shredding in the case of paper, before delivery to the recycling enterprise.

These and other aspects of the invention are described in the detailed description of the invention and claimed in the claims that follow.

### BRIEF DESCRIPTION OF THE DRAWINGS

There will now be described preferred embodiments of the invention, with reference to the drawings, by way of illustration only and not with the intention of limiting the scope of the invention, in which like numerals denote like elements and in which:

FIG. 1 is a schematic showing an embodiment of the invention; and

FIG. 2 is a schematic showing a payment mechanism for a charity in accordance with a method of the invention.

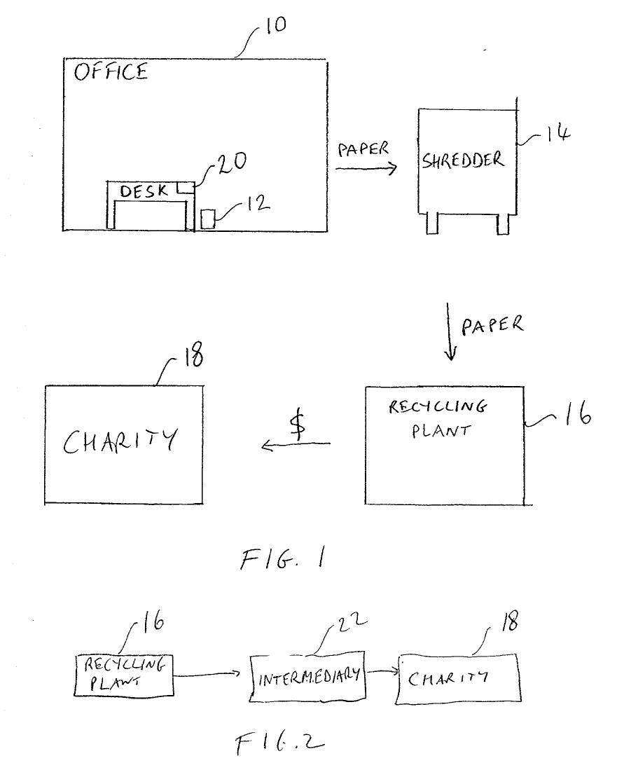

### DEAILED DESCRIPTION OF PREFERRED EMBODIMENTS

In this patent document, the word comprising” is used in its non-limiting sense to mean that items following the word in the sentence are included and that items not specifically mentioned are not excluded. The use of the indefinite article “a” in the claims before an element means that one of the elements is specified, but does not specifically exclude others of the elements being present, unless the context clearly requires that there be one and only one of the elements.

In a preferred method of waste disposal according to the invention, an office 10, or other commercial or industrial location that collects recyclable waste, is provided with a bin 10 for receiving waste paper, which may be documents that require secure disposal. Paper is collected from the bin 12, shredded in shredder 14, then delivered to a recycling enterprise 16 in return for a payment for the shredded paper. The payment, or a part of it, for the shredded paper is then donated to a charity 18. Preferably, indicia 20, such as a sign, indicating the name of the charity 18 is placed in a suitable location near the bin 12. Each bin 12 may be associated with an account, having a number. Paper from that bin may be weighed and the amount of paper recorded against that account. When payment for the total collected paper from the recycling plant 16 is made by the recycling plant, the account may be credited with an amount that is equal to the amount of money payable by the recycling plant 16 for the amount of paper from the bin 12. In this way, payments associated with the bin are tracked using the account number. To ease tracking of the paper from the bin 12, the account number may be marked on the bin 12.

While a preferred method of the invention has been described in relation to paper, the material being recycled may be any recyclable material, as for example bottles or cans. The bin 12 may be any suitable receptacle for collecting recyclable waste. The recyclable waste may be processed before delivery to the recycling plant, as for example shredding by the shredder 14 or crushing in the case of cans.

The charity 18 may be any suitable charity, such as a charity devoted to the interest of children, an example being World Vision. The payment to the charity 18 by the recycling plant 16 may be made through any suitable intermediary, such as a bank 22 or the shredding company that owns the shredder 14. The shredding company would also be paid by the owner or lessee of the office 10, or the owner or lessee of such other recyclable waste collection location that might be used, in the usual course of business of the shredding company. In the case of shredding of documents requiring secure disposal, the usual security precautions are taken.

A person skilled in the art could make immaterial modifications to the invention described in this patent document without departing from the essence of the invention.

What is claimed is:

1. A method of secure disposal of documents, the method comprising the steps of:
providing a bin at a document collection location for receiving paper;
collecting the paper from the bin and shredding the paper to produce shredded paper;
delivering the shredded paper to a recycling enterprise in return for a payment; and
donating at least a portion of the payment to a charity.

2. The method of claim 1 in which all of the payment is donated to charity.

3. The method of claim 1 further comprising the step of arranging the display of indicia of the charity at the recyclable waste collection location.

4. The method of claim 1 in which each bin is associated with an account having a number and payments associated with the bin are tracked using the account number.

5. The method of claim 4 in which the account number is marked on the bin.

6. The method of claim 1 in which the recyclable waste collection location is in an office.

7. The method of claim 6 in which the bin is a paper bin.

8. The method of claim 1 in which the charity is devoted to the interest of children.

9. The method of claim 1 in which the charity is World Vision.

10. A method of waste disposal, the method comprising the steps of:
providing a bin at a recyclable waste collection location for receiving recyclable waste;
collecting the recyclable waste from the bin and delivering the recyclable waste to a recycling enterprise in return for a payment; and
donating at least a portion of the payment to a charity.

11. The method of claim 10 in which all of the payment is donated to charity.

12. The method of claim 10 further comprising the step of arranging the display of indicia of the charity at the recyclable waste collection location.

13. The method of claim 10 in which each bin is associated with an account having a number and payments associated with the bin are tracked using the account number.

14. The method of claim 13 in which the account number is marked on the bin.

15. The method of claim 10 in which the charity is devoted to the interest of children.

16. The method of claim 10 in which the charity is World Vision.
